(19) United States
(12) Patent Application Publication
(10) Pub. No.: US 2004/0212206 A1
(43) Pub. Date: Oct. 28, 2004

(54) Micro/nano clutching mechanism

(75) Inventors: Kaicheng Chang, Taipei (TW); Guang-Chyeng Fan, Hsinchu (TW)

Correspondence Address: BACON & THOMAS, PLLC, 625 SLATERS LANE, FOURTH FLOOR, ALEXANDRIA, VA, 22314

(73) Assignee: Industrial Technology Research Institute, Hsinchu (TW)

(21) Appl. No.: 10/601,596

(22) Filed: Jun. 24, 2003

(30) Foreign Application Priority Data
Apr. 23, 2003 (TW) 92206442

(51) Int. Cl. B25J 7/00; B66C 1/42

(52) U.S. Cl. 294/99.1

(57) ABSTRACT

A clutching mechanism includes at least one elastic layer with a deformable area in which at least two micro/nano pins are erected. A driving mechanism is utilized to deform the deformable area in a way that those micro/nano pins move closer to each other. The distance between the tips of those micro/nano pins, namely, the clutching points, is thereby reduced, so as to grasp a micro/nano object. Further, to fit in with the shape of a micro/nano object, those micro/nano pins can be made into various shapes. It is a further effect that, when the driving mechanism is a vacuum pump or a pneumatic pump, the clutching force exerted on a micro/nano object can be adjusted by varying the pressure difference produced by the pump.

### FIELD OF THE INVENTION

This present invention relates to a micro/nano clutching mechanism, and more particularly to a micro/nano clutching mechanism for clutching small objects of micron or nanometer scale.

### BACKGROUND OF THE INVENTION

Micro Electro-Mechanical System, or MEMS, has been worked for twenty years that integrates a variety of engineering disciplines such as mechanics, electronics, control, optics and material sciences. The technology of MEMS is centered on processing microstructures or micro devices, which can be applied to manufacturing micro sensors, integrated circuits, micro controllers, and micro medical instruments.

However, it is difficult to manipulate micro components used in an MEMS manufacturing process. The tools for clutching micro components are very difficult to make. It is also difficult to control the force applied on a micro component by a clutching device.

### SUMMARY OF THE INVENTION

The primary object of the present invention is to provide a micro/nano clutching mechanism for clutching objects of small scale, which is realized by changing the distance between a number of protrusions; the distance variation is caused by deforming the elastic substrate those protrusions are anchored at.

A second object of the present invention is to provide a micro/nano clutching mechanism in which those protrusions can be made into various shapes to fit in with the shape of a micro/nano object.

It is further object of the present invention that the clutching force exerted on a micro/nano object can be adjusted by varying the pressure difference that drives the deformation.

To achieve above object, the present invention provides a micro/nano clutching mechanism comprising: at least one elastic layer which is a thin layer with a rim area surrounding a deformable area; two sides of the elastic layer(s) defining an upper surface and a lower surface; a predetermined number of protrusions erected on the lower surface of the deformable area of the elastic layer(s) and extended outwardly; the predetermined number being at least two; a tip of each of the protrusions defining a clutching point; the clutching points being separated at a predetermined distance; a supporting mechanism anchored on the upper surface of the elastic layer(s) in the rim area; and a driving mechanism deforming the elastic layer(s) in a way that the deformable area is sunken inwardly, and thereby the clutching points of the protrusions moving closer to each other within a distance shorter than the predetermined distance.

Thereby, in the present invention, the driving mechanism serves to deform a deformable area to be sunken inwardly in an elastic layer and thus the two protrusions are inclined with the deformation of the deformable area. The clutching points of the protrusions can move closer to each other, and the protrusions are then capable of clutching a small object. The small object can be of micron or even nanometer scale, such as a single cell organism (a paramecium, for example) or a micro machine (a micro motor, for example).

The shape of the protrusions is selected from a group of a cone, a cylinder, a sloped-top cylinder, a rectangular body, and a triangular cone for capturing a tiny object. The driving mechanism may be a vacuum pump. By the absorbing force of the vacuum pump, the pressure from the vacuum absorption force of the vacuum pump will cause that the deformable area to be concave. By control the pressure difference, the force to capture tiny objects is controllable. In the present invention, the driving mechanism may be an elastic static driving electrodes. That is, a layer of metal is coated on the elastic layer and the supporting mechanism by semiconductor process, such as sputtering or evaporating. Then a current is applied to different metal layers so as to form a positive electrode and a negative electrode. By the absorption of the positive electrode and negative electrode, the deformable area will be concave. Or, the driving mechanism may be a magnet.

Furthermore, the present invention provides a micro/nano clutching mechanism which comprises: at least two elastic layers which are thin layers and are adjacently placed; each of the elastic layers having a rim area surrounding a deformable area; two sides of each of the elastic layers defining an upper surface and a lower surface; at least two protrusions respectively erected on the lower surface in the deformable area of the elastic layers and extended outwardly; a tip of each of the protrusions defining a clutching point; the clutching points being separated at a predetermined distance; at least two supporting mechanisms respectively anchored in the rim area on the upper surface of each of the elastic layers; and at least one driving mechanism deforming the elastic layers in a way that the deformable areas is bulged outwardly, and thereby the clutching points of the protrusions moving closer to each other within a distance shorter than the predetermined distance.

Thereby, in the present invention, the driving mechanism serves to deform two deformable areas to be bulged outwardly in two elastic layers and thus the two protrusions are inclined with the deformation of the deformable areas. The clutching points of the protrusions can move closer to each other, and the protrusions are then capable of clutching a small object. The small object can be of micron or even nanometer scale, such as a single cell organism (a paramecium, for example) or a micro machine (a micro motor, for example).

The shape of the protrusions is selected from a group of a cone, a cylinder, a sloped-top cylinder, a rectangular body, and a triangular cone for capturing a tiny object. The numbers of the protrusions can be more than two. The sizes of the clutched object extends from 0.01μ to 50μ widely. The driving mechanism may be a pneumatic pump. By the charging force of the pneumatic pump, the pressure from the pneumatic force of the pneumatic pump will cause that the deformable areas to be bulged. By control the pressure difference, the force to capture tiny objects is controllable.

The various objects and advantages of the present invention will be more readily understood from the following detailed description when read in conjunction with the appended drawing.

### BRIEF DESCRIPTION OF THE DRAWINGS

FIG. 1 is a perspective view of the first preferred embodiment of the present invention.

FIG. 2 is a cross-sectional view of the first preferred embodiment of the present invention before activating the driving mechanism.

FIG. 3 is a cross-sectional view of the first preferred embodiment of the present invention after activating the driving mechanism.

FIG. 4 is a perspective view of different version of micro pins in the first preferred embodiment of the present invention.

FIG. 5 is a perspective view of another version of micro pins in the first preferred embodiment of the present invention.

FIG. 6 is a perspective view of the second preferred embodiment of the present invention.

FIG. 7 is a cross-sectional view of the second preferred embodiment of the present invention before activating the driving mechanism.

FIG. 8 is a cross-sectional view of the second preferred embodiment of the present invention after activating the driving mechanism.

FIG. 9 is a perspective view of another version of micro pins in the second preferred embodiment of the present invention.

FIG. 10 is a perspective view of the third preferred embodiment of the present invention.

FIG. 11 is a cross-sectional view of the third preferred embodiment of the present invention before activating the driving mechanism.

FIG. 12 is a cross-sectional view of the third preferred embodiment of the present invention after activating the driving mechanism.

### DETAILED DESCRIPTION OF THE PREFERRED EMBODIMENTS

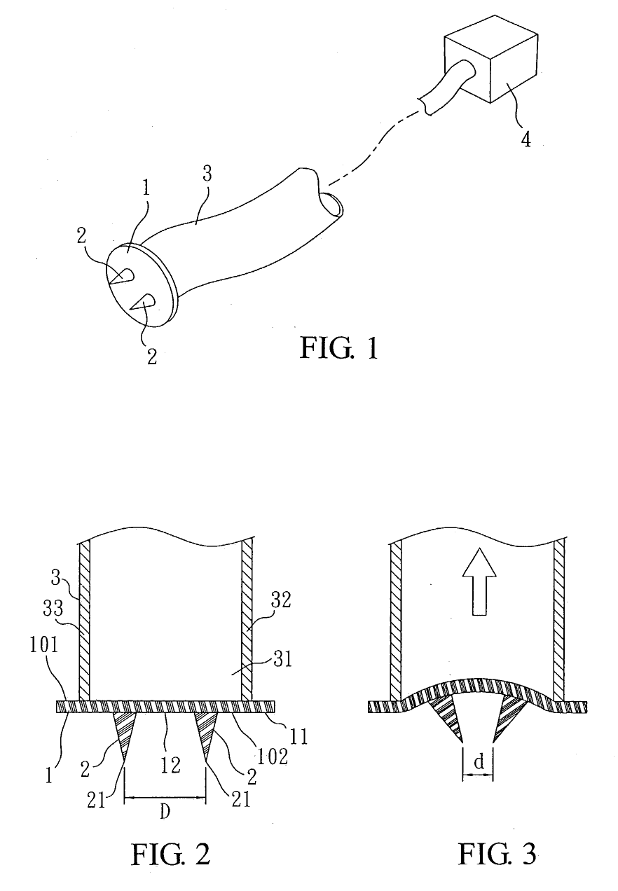

Referring to FIG. 1, FIG. 2, and FIG. 3, a preferred embodiment according to the present invention as a micro/nano clutching mechanism comprises an elastic layer 1, two micro pins 2, a supporting mechanism 3, and a driving mechanism 4. The elastic layer 1 is a thin layer consisting of a rim area 11 and a deformable area 12, two sides of which layer respectively define an upper surface 101 and a lower surface 102. Two micro pins 2 are formed on the lower surface 102 of the deformable area 12 of the elastic layer 1. The tips of these two micro pins 2 form a pair of clutching points 21, separated apart by a predetermined distance D. The supporting mechanism 3 is a hollow tube 31. One end of the hollow tube 31 is connected to the upper surface 101 of the elastic layer 1 by adhering the cross-sectional rim of the hollow tube 31 to the rim area 11 of the elastic layer 1. Aforementioned supporting mechanism 3 can not only be the hollow tube 31, but also any elongation with an axial hollow inside. In the embodiment the elastic layer 1 is a round thin layer made of silica gel, but PDMS, or other flexible materials, or other suitable composite material can also be used. The micro pins 2 are formed on the lower surface 102 of the deformable area 12 of the elastic area 1; the micro pins 2 are arranged uniformly in the pattern of an equilateral polygon.

The driving mechanism 4 of the preferred embodiment is a vacuum pump, which is connected to the hollow tube 31 of the supporting mechanism 3. As the vacuum pump of the driving mechanism 4 extracts gases from the hollow tube 31, the deformable area 12 of the elastic layer 1 is sunken into the hollow tube 31 by the pressure difference between the tube interior and the outside. Simultaneously, the micro pins 2 are tilted toward the center of the deformable area 12 so that the distance between the clutching points 21 of the micro pins 2 shrinks from D to a smaller d. The clutching points 21 of the micro pins 2 are then capable of clutching a small object of scale around d. The small object can be of micron or even nanometer scale, such as a single cell organism (a paramecium, for example) or a micro machine (a micro motor, for example). Once a small object is captured, the force exerted on it can be adjusted by varying the pressure difference produced by the vacuum pump.

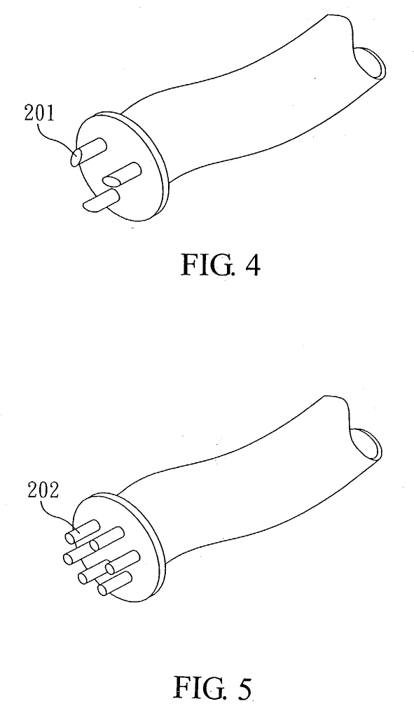

In this preferred embodiment the shape of the micro pins 2 is a cone. However, as shown in FIG. 4, the micro pins 201 may also have the shape of a sloped-top cylinder. As shown in FIG. 5, the micro pins 202 may also have the shape of a cylinder. Generally, the shape of micro pins can be a cone, a sloped-top cylinder, a cylinder, a rectangular body, or even a triangular body. The semiconductor manufacturing processes can use to make the micro pins 2, 201, 202.

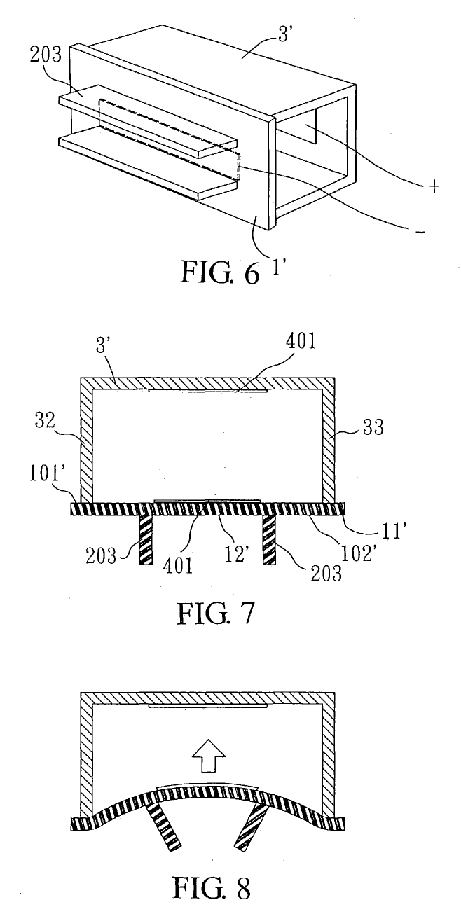

Referring to FIG. 6, FIG. 7, and FIG. 8, the second preferred embodiment according to the present invention as a micro/nano clutching mechanism has a structure similar to the first preferred embodiment. In this preferred embodiment, however, the elastic layer 1′ is a rectangular thin layer, and the supporting mechanism 3′ is comprising two lateral sides 32, 33 and are anchored along two opposite sides of the rim area 11′ on the upper surface 101′ of the elastic layer 1′. The micro pins 203, now two parallel long slabs, are anchored at the deformable area 12′ on the lower surface 102′ of the elastic layer 1′. Further, the driving mechanism 401 is a pair of electrodes, which are metallic films, one on the deformable area 12′ of the upper surface 101′ and the other on the surface of the supporting mechanism 3′ opposite to the upper surface 101′. The metallic films can be formed by evaporation deposition or sputtering deposition commonly used in semiconductor manufacturing processes. Two metallic films are charged oppositely by an external voltage source, thereby forming a pair of electrodes of opposite polarities. The electrostatic attraction between the electrodes deforms the deformable area 12′ of the elastic layer 1 to sink inwardly, achieving the same clutching effect as the first preferred embodiment. To achieve a similar deformation by attraction forces, the electrodes can also be replaced by electromagnets.

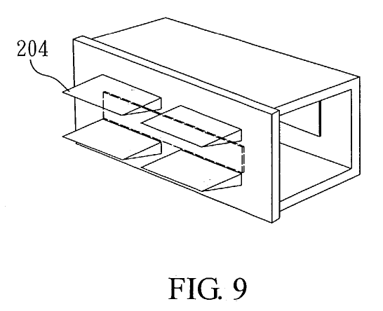

Referring to FIG. 9, the micro pins 204 can be 4 wedge-shaped objects arranged in a 2 by 2 square array. As in the first preferred embodiment, there is no particular restriction on the shape of the micro pins; they can be a cone, a sloped-top cylinder, a cylinder, a rectangular body, or even a triangular body.

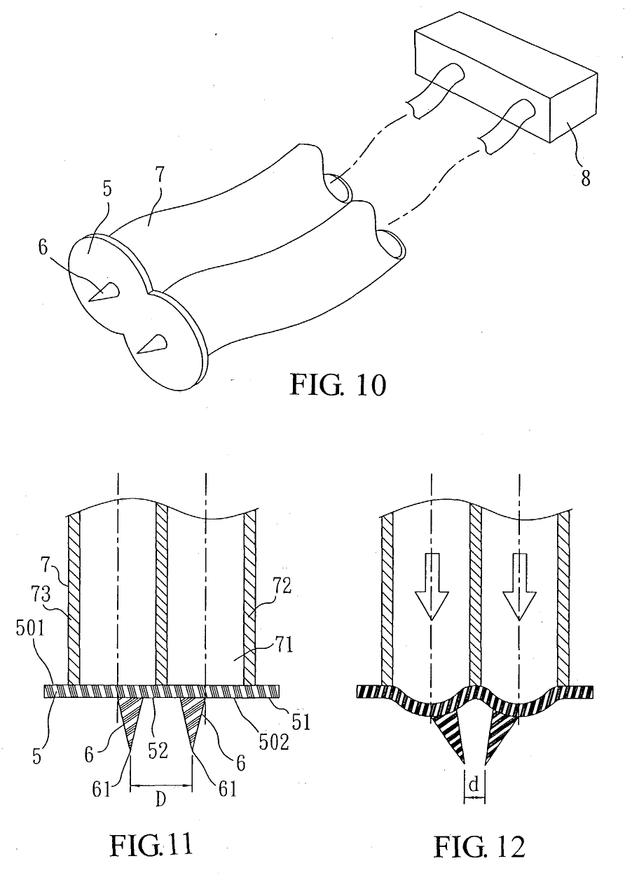

Referring to FIG. 10, FIG. 11, and FIG. 12, the third embodiment according to the present invention comprises two elastic layers 5, two micro pins 6, two supporting mechanisms 7, and a driving mechanism 8. Two elastic layers 5 are integrated into a thin layer, consisting of a rim area 51 and a deformable area 52 respectively. Two sides of the thin layer respectively define an upper surface 501 and lower surface 502. Two micro pins 6 are erected respectively in the deformable areas 52 on the lower surfaces 502 of the two elastic layers 5. The tips of these two micro pins 6 form a pair of clutching points 61, separated apart by a predetermined distance D. Those two supporting mechanisms 7 are hollow tubes 71. One end of each of those hollow tubes 71 is respectively connected to the upper surface 501 of a region defined by an elastic layer 5 by adhering the rim of each hollow tube 71 to the rim area 51 of the region. In this embodiment those elastic layers 5 are round thin layers made of silica gel, but PDMS, or other flexible materials, or other suitable composite materials can also be used. The axes of the hollow tubes define two centerlines. It should be noted that micro pins 6 are located off the centerlines toward each other to acquire a suitable distance between those clutching points 61.

The driving mechanism 8 of the preferred embodiment is a pneumatic pump, which is coupled to the hollow tubes 71 of the supporting mechanisms 7. As the pneumatic pump of the driving mechanism 8 provides gases to the hollow tubes 71, the deformable area 52 of those elastic layers 5 is bulged outwardly to the center thereof by a pressure difference between the tube interior and the outside. Simultaneously, the micro pins 6 are tilted toward the center of the deformable areas 52 so that the distance between the clutching points 61 of the micro pins 6 shrinks from D to a smaller d. The clutching points 61 of the micro pins 6 are then capable of clutching a small object of dimensions around d. The small object can be of micron or even nanometer scale, such as a single cell organism (a paramecium, for example) or a micro machine (a micro motor, for example). Once a small object is captured, the force exerted on it can be adjusted by varying the pressure difference produced by the pneumatic pump.

The shape of the micro pins 6 in this preferred embodiment is a cone. As in the first preferred embodiment, the micro pins 6 may also have the shape of a cone, a sloped-top cylinder, a cylinder, a rectangular body, or even a triangular body, depending on the shape of the micro/nano objects we intend to grasp. It is a further flexibility that the driving mechanism 8 can be electrodes or electromagnets that utilize electrostatic force or magnetic force to deform the deformable areas 52.

The present invention is thus described, and it will be obvious that the same invention may be varied in many ways. Such variations are not to be regarded as a departure from the spirit and scope of the present invention, and all such modifications as would be obvious to one skilled in the art are intended to be included within the scope of the following claims.

What is claimed is:

1. A clutching mechanism comprising:
at least one elastic layer which is a thin layer with a rim area surrounding a deformable area; two sides of said elastic layer defining an upper surface and a lower surface;
at least two protrusions erected on said lower surface of said deformable area of said elastic layer(s) and extended outwardly; a tip of each of said protrusions defining a clutching point; said clutching points being separated at a predetermined distance;
a supporting mechanism anchored on said upper surface of said elastic layer(s) in said rim area; and
a driving mechanism deforming said elastic layer in a way that said deformable area is sunken inwardly, and thereby said clutching points of said protrusions moving closer to each other within a distance shorter than said predetermined distance.

2. The clutching mechanism of claim 1, wherein said elastic layer(s) is made of elastic silica gel materials.

3. The clutching mechanism of claim 1, wherein said elastic layer(s) is a round thin layer and said supporting mechanism is a hollow tube, a rim of a cross section of said hollow tube being fixed to said rim area of said upper surface of said elastic layer(s), said protrusions are arranged uniformly in a pattern of an equilateral polygon in said deformable area on said lower surface of said elastic layer(s).

4. The clutching mechanism of claim 1, wherein said elastic layer(s) is a rectangular thin layer; said supporting mechanism consisting of two parallel rectangular walls anchored respectively along two opposite sides of said rim area on said upper surface of said elastic layer(s); said protrusions being arranged in parallel in said deformable area on said lower surface of said elastic layer(s).

5. The clutching mechanism of claim 1, wherein the shape of said protrusions is selected from a group of a cone, a cylinder, a sloped-top cylinder, a rectangular body, and a triangular cone.

6. The clutching mechanism of claim 1, wherein said driving mechanism is a vacuum pump.

7. The clutching mechanism of claim 1, wherein said driving mechanism is a pair of charged electrodes.

8. A clutching mechanism comprising:
at least two elastic layers which are thin layers and are adjacently placed; each of said elastic layers having an outer rim area and an inner deformable area; two sides of each of said elastic layers defining an upper surface and a lower surface;
at least two protrusions respectively erected on said lower surface in said deformable area of said elastic layers and extended outwardly; a tip of each of said protrusions defining a clutching point; said clutching points being separated at a predetermined distance;
at least two supporting mechanisms respectively anchored in said rim area on said upper surface of each of said elastic layers; and
at least one driving mechanism deforming said elastic layers in a way that said deformable areas is bulged outwardly, and thereby said clutching points of said protrusions moving closer to each other within a distance shorter than said predetermined distance.

9. The clutching mechanism of claim 8, wherein said elastic layers are made of elastic silica gel materials.

10. The clutching mechanism of claim 8, wherein said supporting mechanisms are each a hollow tube, a rim of a cross section of said hollow tube being adhered to said rim area of said upper surface of each of said elastic layers.

11. The clutching mechanism of claim 8, wherein said the shape of said protrusions is selected from a group of a cone, a cylinder, a sloped-top cylinder, a rectangular body, and a triangular cone.

12. The clutching mechanism of claim 8, wherein said driving mechanism is a pneumatic pump.
